(19) United States
(12) Patent Application Publication
(10) Pub. No.: US 2009/0244261 A1
(43) Pub. Date: Oct. 1, 2009

(54) METHOD FOR THE THREE-DIMENSIONAL MEASUREMENT OF FAST-MOVING OBJECTS

(76) Inventor: Bernward Maehner, Gilching (DE)

Correspondence Address: Stephen B. Salai, Esq.;Harter Secrest & Emery LLP, 1600 Bausch & Lomb Place, Rochester, NY, 14604-2711, US

(21) Appl. No.: 12/294,008

(22) PCT Filed: Sep. 23, 2006
(86) PCT No.: PCT/EP06/61017

§ 371 Date: Sep. 22, 2008

(51) Int. Cl. H04N 13/02

(52) U.S. Cl. 348/46; 348/E13.074

(57) ABSTRACT

Light sectioning or fringe projection methods are used to measure the surface of objects (2). According to said methods, the object (2) is moved past a measuring system (4) and the measured data is recorded during this movement. These methods can only be used for a high-resolution, comprehensive measurement of the surface if the object (2) is moved sufficiently slowly, in relation to the scanning rate of the measuring system (4), past said measuring system (4). To achieve a comprehensive measurement of the object surface, even when the object (2) performs a relatively fast movement, in particular a rotational movement, the object (2) is repeatedly moved past the measuring system (4) and measured. The use of a trigger device for recording the measured values permits the data obtained in the individual passes to be correlated in a three-dimensionally correct manner in relation to one another and the surface of the object to be measured with high resolution.

Triangulation systems comprising a point laser and a line camera are known to be used for three-dimensional object scanning. Systems of this kind find application, for example, on turning lathes for keeping a check on critical dimensions or tolerances in the production of rotational objects. Because of the principle involved only one point on the object is scanned at any one instant, it being possible, however, to employ several systems in parallel. The line rate of commercially available line cameras is as high as 200 kHz and more, so that even with fast rotating workpieces the spacing between the individual scanning points is very small. The drawback of this method is that even when employing several systems only a relatively small number of points can be simultaneously scanned.

This drawback is overcome with the light slice method. Using a line laser instead of a point laser and a surface camera instead of a line camera covers an additional dimension so that instead of just a point a whole contour line is scanned. Unlike line cameras the image frequency of commercially available surface cameras with 25 to 60 frames per second is relatively low, resulting in the object to be scanned needing to be moved past the light slice system sufficiently slowly so as not to exceed a useful three-dimensional spacing between the individual scannings.

One such system is described for example in German patent DE 100 19 386 C2. In the example aspect as shown therein the object rotates relatively slowly at a frequency of approx 0.5 Hz about the axis of rotation, resulting in the image frequency of the video camera used being approx. 25 Hz which is sufficiently high. But for scanning fast-moving objects such as a tyre rotating at a frequency of approx. 10 Hz on a roller test rig to achieve a comparable frequency ratio a significantly faster camera needs to be used with an image frequency of approx. 500 Hz. Such high-speed cameras add considerably to the costs as compared to standard cameras, however.

In the fringe projection method instead of a line laser a fringe projector is used, so that instead of a contour line a whole surface can be scanned topometrically, for which a wealth of different projection techniques is known. For example, a method is described in German patent DE 38 43 396 C1 in which just a single fringe pattern needs to be projected for scanning.

Both laser triangulation as well as fringe projection techniques are subject in principle to the problematics involved in shading, i.e. points on the test object which although “seen” by the camera cannot be scanned because of the topometry of the object not being beamed simultaneously by the laser or projection beam. To minimize the problematics involved it is known from the German laid-open document DE 197 41 730 A1 to pass the object with a rotating or longitudinally oscillating motion repeatedly past the sensor in simultaneously causing it to perform a longitudinal oscillation or rotational motion respectively. This renders the individual surface portions of the object “seen” by the scanning system from several different directions of observation in thus eliminating the shading problematics.

Known furthermore from technical applications is a stroboscopic flashing for observing fast-moving objects or oscillating objects. Flashing freezes the image of the object being observed for the observer phase-locked within a motion period of the object. This is also made use of in testing. For example, to test for correct ignition of a spark-ignition engine a stroboscope lamp is triggered by the primary circuit of the ignition. When the flywheel of the engine featuring the position marks of the crankshaft is strobed it is possible for the observer to check the ignition timing as regards the crankshaft setting with the engine running. Another application of the stroboscope is the analysis of vibrating objects. In this case the phasing of the stroboscope flash is continually offset relative to the periodic motion of the object, enabling the shape of the vibration of the object to be observed practically in slow motion since the vibration of the object is rendered visible to the observer with the velocity of the change in phasing.

For analyzing the deformation of an object activated periodically, particularly sinusoidally by a fringe projection technique it is proposed in German patent DE 198 41 365 C2 to trigger imaging by the camera of the scanning system phase-locked relative to the activating the oscillation and with a stroboscopic short exposure time, “freezing” a phase-dependent deformation condition of the object being dynamically deformed in making it accessible for quantitative analysis. The drawback here is, however, that to sense a quasistatic condition of the object the imaging time needs to be selected so short that the camera image is underexposed. To get round this problem the exposure of the camera is triggered in a series of oscillations phase-locked, resulting in the light energy incident on the sensor of the camera accumulates producing an image with good output level control.

On the basis of this prior art it is an object of the invention to define a method now making it possible to scan fast-moving objects by means of light slice or fringe projection techniques. The method is intended to avoid having to use special and thus expensive hardware, it instead being limited to the use of commercially available components.

This object is achieved by a method having the features as set forth in claim 1. Preferred aspects of the method in accordance with the invention are defined in claims 2 to 18.

In accordance with the invention a three-dimensional scanner is used comprising a projector and one or more light slice planes and a surface contour. The projector comprises preferably a line laser or a fringe pattern projector. The surface contour is preferably an electronic CCD or CMOS camera.

In accordance with the invention the object is repeatedly moved past the sensor in a plurality of cycles. Such a motion may involve, for example, rotating the object about an axis of rotation fixedly positioned relative to the scanner. During a cycle only discrete portions of the object surface are sensed by the sensor in accordance with the invention, i.e. a number of portions smaller than the total of all portions as can be scanned in a complete scan. In accordance with the invention several cycles are implemented such that the portions of the object surface scanned in the discrete cycles are each staggered three-dimensionally relative to the object. For this purpose for a new cycle the object positions for mapping the scan data are preselected so that portions of the object surface are scanned which in previous cycles were still to be scanned. This procedure is applied in as many cycles as is needed until the object surface has been scanned with the wanted scanning density. Scanning the object surface is thus distributed in all over several cycles so that even with a relatively slow scanning system the surface of the object can still be scanned with a high scanning density.

If the contour data obtained from the scanned portions do not need a three-dimensional assignment, i.e. if no surface model of the object is needed, then there is no need to transform the obtained contour data into a common system of object coordinate system. If the object performs a periodic rotational or oscillatory motion relative to the scanner then in this case the method in accordance with the invention is applied to advantage that the camera is operated with as high an image frequency or imaging frequency as possible. The image frequency or imaging frequency is tweaked relative to the motion frequency of the object so that the positions of the object captured in the discrete camera images, as viewed over the motion periods of the object, wander along the object. After an adequate number of motion periods of the object this results in total coverage in scanning the contour of the object without any further expensive hardware being needed.

One example of application for this embodiment of the invention is for example scanning rims or tyres in testing them for their true running properties, i.e. involving only their maximum radial and lateral run-out. In this application it is sufficient to compute, for instance, the extreme values obtained from all scanned three-dimensional coordinates in axial and radial direction.

By contrast, a further optional step in the method involves transforming the contour data of the scanned portions into a common object coordinate system and generating from the transformed contour data a surface model of the object. This step in the method requires precise knowledge of the location of all scanned portions each relative to the other and relative to the object. This information is obtained in accordance with the invention by each momentary position of the object being mapped for every imaging of the scan data by the camera.

Sensing the momentary position is done to advantage by means of a position transducer which in an embodiment of the method suitable for all rotational or oscillation motions of the object may be, when for example rotational motions are involved, a shaft encoder or where translational motions are involved a linear displacement transducer. In both cases imaging by the camera is triggered every time a critical value as established by the position transducer is attained and the reading for further processing together with the image data memorized.

Where a periodic rotational or oscillatory motion of the object is involved the method is performed to advantage such that each scanning position is selected timed. For precise timing preference is given to a real-time compatible microprocessor, for example a computer-controlled counter card which triggers imaging by the camera at predefined instants. The advantage of this embodiment is that no high-resolution shaft encoder or linear displacement transducer needs to be employed. If the scanner has no means of directly monitoring the motion of the object, a reference signal emitter is made use of which generates a reference signal for synchronizing the timing to the motion of the object. The three-dimensional position of the object existing at a certain instant of imaging is then established from the time spacing between having received a synchronizing pulse in the reference signal or the imaging instant.

To prevent the object positions scanned over the imaging instants from drifting away from the true object positions, the timing is synchronized to the motion of the object, for example, once per period. Sufficient for this purpose is a signal source emitting a synchronizing pulse per period at a certain momentary position of the object. This synchronizing pulse is then used, on the one hand, to advantage in sensing the instant period length of the objection motion and, on the other, to always relate the imaging instants to the synchronizing pulse received last before or firstly after the corresponding imaging.

In all of the aspect variants discussed precise imaging by the camera of the scanning system is of prime importance. To image the camera at the instant as computed by the imaging processor in accordance with a further embodiment of the invention a mechanical or electronic camera shutter for release by an external signal is used, although it is just as possible to use a camera whose imaging can be triggered externally, whereas in another embodiment the light source of the scanning system, for instance a line laser module, is strobed by a mechanical shutter or electronic switching device. In this arrangement, the time spacing between two imagings in sequence for scanning the portions of the object surface is to advantage always selected greater than the image period of the camera to safely exclude a double exposure of frames or fields imaged by the camera. This ensures that no difficulties are experienced in subsequent image analysis as is obligatory for light slice or fringe projection systems. Since the object is scanned on the move, the imaging time is selected sufficiently short, it amounting to a fraction of an image period with electronic cameras. Of advantage in this respect is that timing the exposure is controlled by the camera itself even when the camera shutter or imaging advance is triggered externally.

Where a periodic rotational or oscillatory motion of the object is involved a further embodiment of the invention provides for the camera being left to run free or with a fixed image frequency and to provide no external asynchronous release of the camera shutter. The image frequency is selected so that the scanning positions as viewed over the motion periods of the object wander along the object. For this purpose it is sufficient to ensure that image frequency and motion frequency relate to each other such that it is assured that identical portions do not repeat before an adequate number of cycles is attained. Such a ratio is always non-integer.

For each camera image the time spacing between imaging and the instant at which the object has attained a certain reference position is sensed. For this purpose a reference signal is generated to advantage which at least once per period generates a synchronizing pulse for a certain momentary position of the object. By measuring the time having passed between imaging and attaining the reference position a time value is obtained for each image which is equivalent to the position of the object when the motion of the object is periodic. By means of the measured time values the contour data of the portions scanned in the individual images are transformed into a common system of coordinates of the object. If the precise imaging instant of the camera cannot be sensed, because, for example, the internal shutter function of the camera cannot be picked off externally, the time interval between the synchronizing pulse of the object motion and the vertical synchronizing pulse in the video signal can be used for measuring the time values, resulting in all in an offset constant for all time intervals sensed. To measure the time intervals a real-time compatible microprocessor, for example in the form of a counter card can be used to advantage, integrated for example in the computer system of the image processor.

Example aspects of the invention will now be detained with reference to the drawings in which:

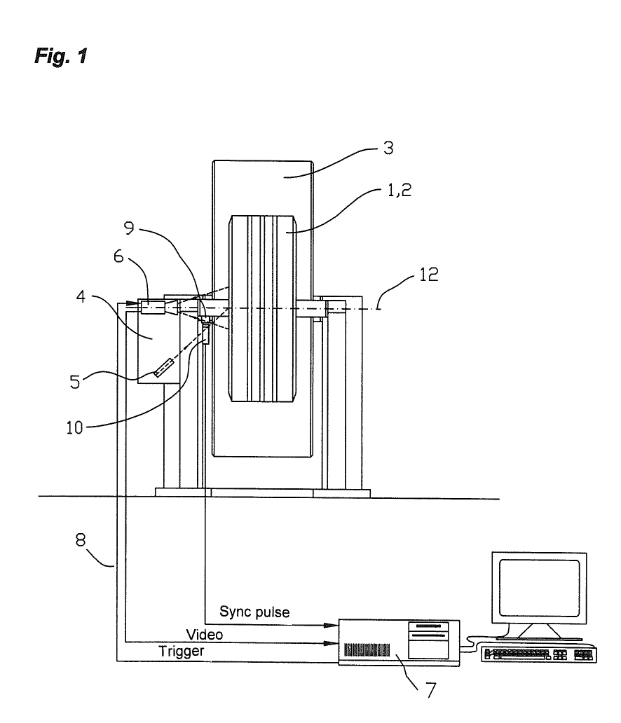

FIG. 1 is a diagrammatic illustration of the system for implementing the method in accordance with the invention in a first embodiment;

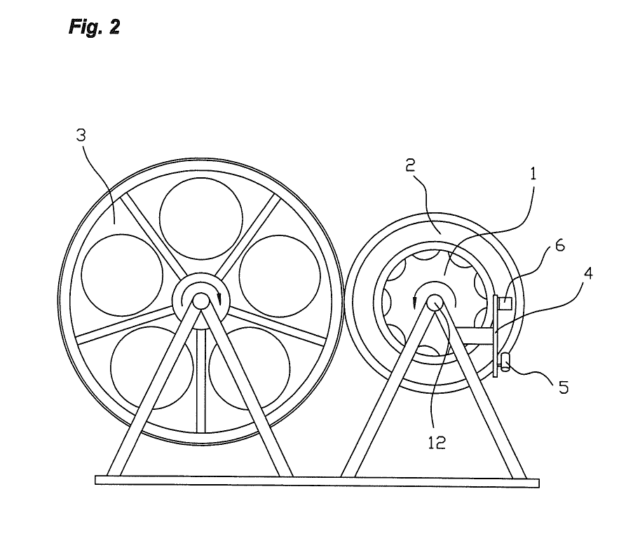

FIG. 2 is a side view of the system as shown in FIG. 1;

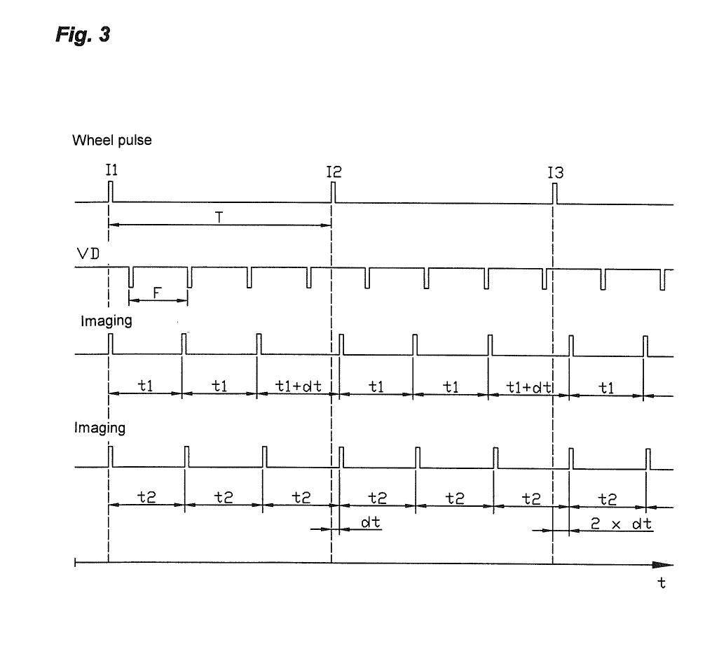

FIGS. 3,4,5,6 are diagrams of the imaging instant for the system as shown in FIG. 1;

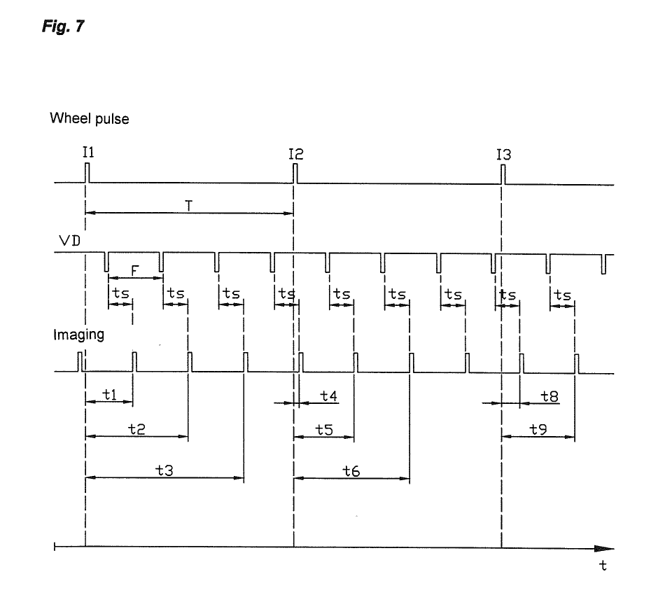

FIG. 7 is a diagram of the imaging instant for a system for implementing the method in accordance with the invention in a second embodiment;

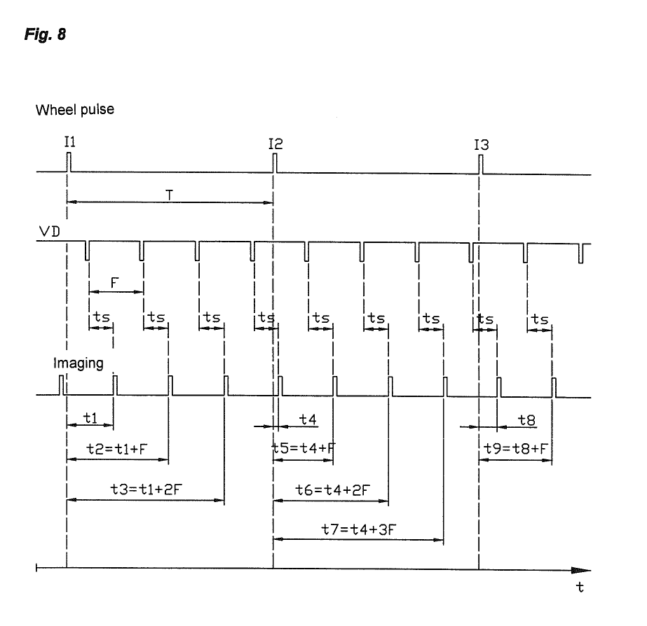

FIG. 8 is a diagram of the imaging instant for a system as shown in FIG. 7 but with another computation of the imaging instants;

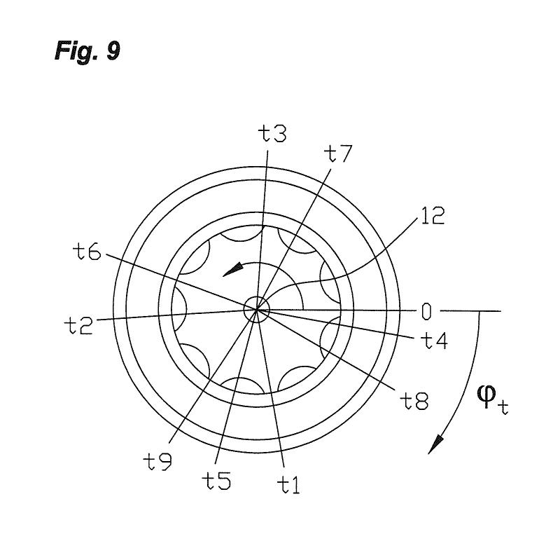

FIG. 9 is an illustration showing the location of light slices on an object by the method as shown in FIGS. 7 and 8, and

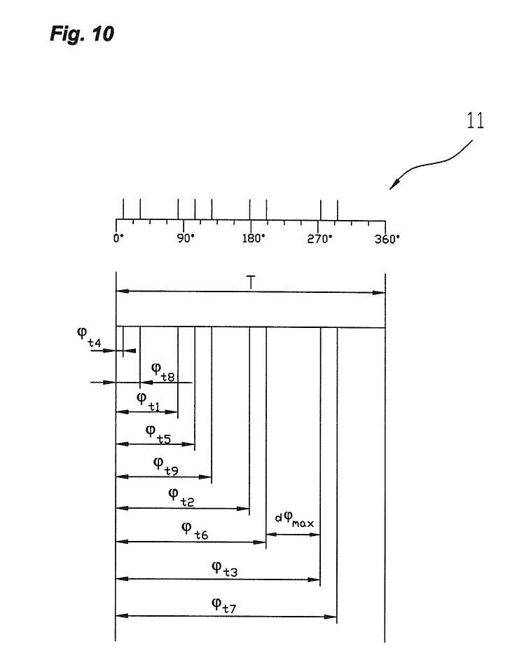

FIG. 10 is an illustration showing how an OFF criterion is determined and a process visualization for the methods as shown in FIGS. 7 and 8.

Referring now to FIGS. 1 and 2 there is illustrated diagrammatically the configuration of a test system for implementing the method in accordance with the invention in a front view and side view. On a roller test rig for vehicle tyres a wheel 1 is pressed against a drive roller 3. The drive roller 3 is powered by a variable speed electric motor, whereas the wheel 1 with the tyre 2 to be tested is powered via the drive roller 3. The pressure force and drive speed are adjustable to thus permit simulating various driving and load conditions. Fitted to one side of the tyre 2 is a light slice light slice scanner 4 to scan a sidewall of the tyre 2 during testing. The light slice scanner 4 comprises a camera 6 and a line laser module 5. The light slice scanner 4 is connected to a computer system 7 fitted with a processor for processing the image data furnished by the camera 6. The camera 6 of the light slice scanner 4 is equipped with a asynchronous electronic shutter which can be released by the computer system 7 by means of a control signal communicated via a signal line 8. Fitted to the spindle 12 of the wheel 1 is a pulser 9 which on passing by a sensor 10 triggers a pulse. For every wheel revolution a pulse is triggered. The pulses of the sensor 10 are captured by the computer system 7. In the practical case of application a further light slice scanner 4 is fitted to simultaneously scan the second sidewall of the tyre 2.

The roller test rig is first regulated to a constant speed. By way of the pulses emitted by the sensor 10 the computer system 7 computes the period length of a wheel revolution, from which a suitable series of imaging instants is computed. After this, a series of images is captured at computed imaging instants, the imaging instants being checked by the computer system 7. For this purpose the computer system 7 is equipped with a real-time compatible counter card which on timeout of programmable time intervals releases the shutter on the camera 6 via the signal line 8. Each time interval is selected so that the time spacing between two imagings in sequence is greater than the image periods of the camera in thus excluding a double exposure of the camera images. The imaging time is checked by the camera 6 itself and is so short that the images of the tyre 2 are sufficiently crisp. Imaging the series is discontinued as soon as a sufficient number of light slices has been captured, distributed as best possible uniformly over the circumference of the wheel.

As regards the number of light slices captured as a maximum per wheel revolution, three cases are distinguished:
1^{st} case: low speed, i.e. several camera shots are possible per wheel revolution
2^{nd} case: medium speed, i.e. one camera shot is possible per wheel revolution
3^{rd} case: high speed, i.e. less than one camera shot is possible per wheel revolution.

Referring now to FIGS. 3 to 7 there are illustrated the signals and respectively the conditions deciding how the imaging instants are selected. The curves “wheel pulse”, “VD” and “imaging” mean hereinafter: the curve “wheel pulse” shows the synchronizing pulse emitted once per revolution of the wheel. The curve “VD” shows the image timing of the camera 6 running free, i.e. continually imaging. The spacing between two pulses of the VD curve corresponds to the image period F. Depending on the type of camera involved the image timing corresponds to either a frame or a field. The curve “imaging” shows at which instants imaging is triggered on the camera. In the case as shown imaging is triggered on a positive-going signal.

Referring now to FIG. 3 there is illustrated a diagram of the imaging instants for the system as described above in the first case, i.e. when several imagings are possible per wheel revolution. This is the case when the period length T of a wheel revolution is greater than the time between two video images. Two variants are shown as regards the imaging instants. The first (=upper) variant uses imaging instants which on a time spacing of t1=T/3 are each staggered by 120° within a wheel revolution. In the transition from one revolution to the next of the wheel an additional time interval dt is waited for to ensure that the three light slices imaged within the following wheel revolution are staggered relative to those of the previous revolution at the circumference of the wheel. The time interval dt may correspond to an angle of rotation of 0.5°, for example, where dt=T/720. After 240 revolutions (=120°/0.5°) the wheel is scanned with 720 light slices on a spacing of 0.5°.

An alternative variant for establishing the imaging instants is shown in the imaging curve depicted below, using time intervals t2 between two imagings which are always constant. The time spacing t2 is selected, for example, so that it corresponds to (T+dt)/3. When, for instance, dt corresponds to an angle of rotation of the wheel of 0.50 the wheel is scanned ultimately in 720 revolutions (=120°/(0.5°/3)) with 2160 light slices on a spacing of 0.5°/3.

Since in the system as shown in FIG. 1 there is no fixed translation ratio between the drive roller 3 and wheel 1 the rotational speed of the wheel 1 may be subject to unwanted fluctuations or slip. This is why it is good practice to relate the instant for the first imaging within a period to the wheel pulse last received in each case. The time spacing for the first imaging each time within a period of the revolution of the wheel is given by n×dt where n is the number of revolutions of the wheel, resulting in scanning being synchronized once per wheel revolution.

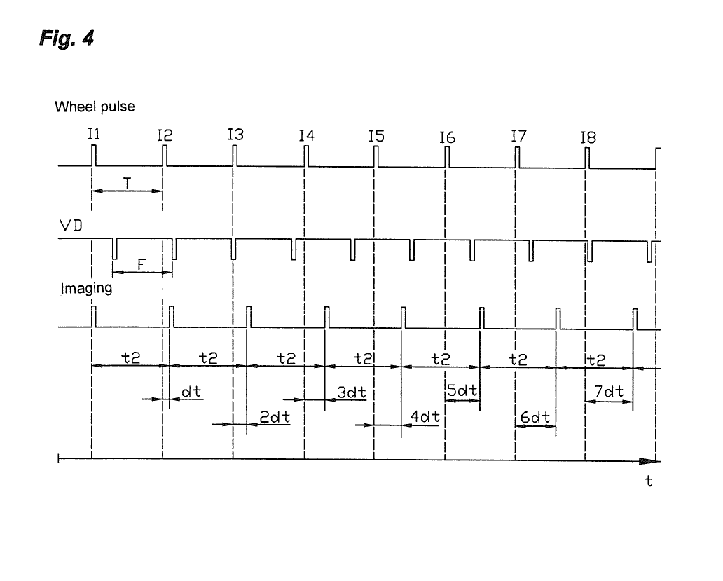

Referring now to FIG. 4 there is illustrated an imaging time diagram for the system as shown in FIG. 1 but for the second case, i.e. when the frequency of rotation of the wheel 1 is only slightly smaller than the image frequency of the camera 6. The imaging instant diagram shows that there is now just one camera shot per wheel revolution. The time spacing t2 between two imagings is selected so that it is greater than the period T by dt.

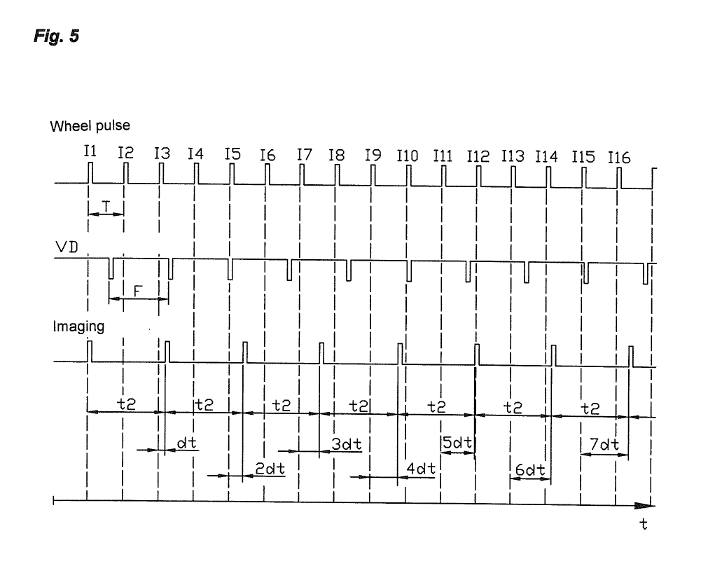

Referring now to FIG. 5 there is illustrated how the imaging instant diagram relates the conditions in application of the method for the third case, i.e. when the rotational frequency of the wheel 1 is greater than the image frequency of the camera 6. In this case imaging is not possible within each wheel revolution.

In the embodiment as shown there is an imaging only in every second wheel revolution. The spacing between two imagings is given by t2=2×T and dt, again where dt is selected so that a sufficiently good sampling rate materializes on completion of scanning.

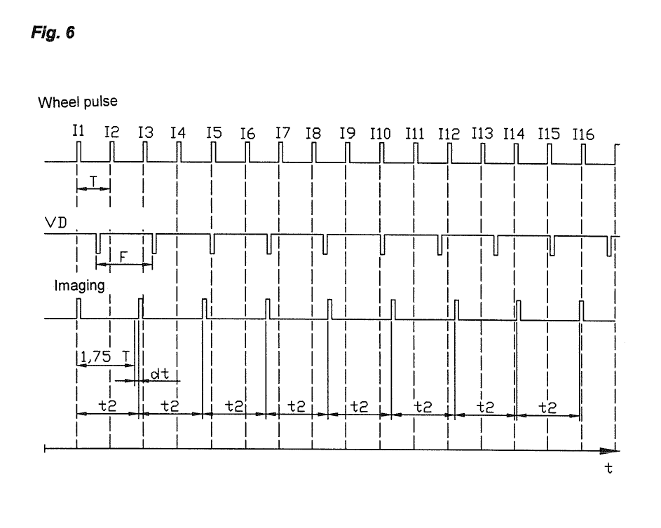

Referring now to FIG. 6 there are illustrated the same conditions as to the rotational frequency of the wheel 1 relative to the image frequency of the camera 6 as in FIG. 5, except that the spacing between two imagings is shorter than in FIG. 5 by t2=1.75×T and dt. This time spacing is, on the one hand, still somewhat larger than the image period F between two camera images, on the other, the scanning time is shorter by 12.5% than that of the embodiment as shown in FIG. 5.

Referring now to FIG. 7 there is illustrated the imaging instant diagram for a system modified as compared to that as shown in FIG. 1 such that there is now no external asynchronous release of the shutter of the camera 6. Furthermore the real-time compatible microprocessor is used to measure the time spacings between imaging and wheel pulse, the camera 6 in this case working with imaging controlled internally in the camera. Since the object, in other words the tyre, is set turning fast in application of the method in accordance with the invention the imaging time is selected significantly shorter than the image period F.

Such a setting of the imaging time is possible on practically every electronic camera 6 by means of an internal electronic shutter. This shutter is automatically released by the free-running camera 6 itself after a certain time t^{s} within an image period F. The computer system 7 measures the times t₁ to t₉ by measuring the time in each case having passed since having received the last wheel pulse and opening of the shutter by the camera 6. The times t₁ to t₉ are proportional to the revolution of the wheel 1 in thus making it possible to arrange the contour lines scanned in the individual camera images relative to each other correctly located as regards the tyre 2.

Referring now to FIG. 8 there is illustrated the imaging instant diagram for a system working the same as that as shown in FIG. 7 except that computing the imaging instants is modified to achieve a particularly simple and cost-effective technical realization involving only the time t1, t4, t8 from the wheel pulse to the first imaging within a revolution of the wheel 1 being measured, for example, with a counter card. The instants of the subsequent imagings within the wheel revolution are then each multiplied by addition of the number of image timings between the first image and the instant image with the constant image period F and the time value of the first image.

Referring now to FIG. 9 there is illustrated which of the rotational positions of the wheel as shown in FIG. 2 correspond to the times t1 to t9 as shown in FIG. 7 and FIG. 8 respectively. Furthermore the indicated reference position 0 corresponds to that of the wheel pulse 11 as shown in FIGS. 7 and 8.

In this approach by the method as shown in FIGS. 7 and 8 the position of the individual scannings at the circumference of the wheel is not necessarily predefined and the rotary angle spacing between two scans in sequence is not constant. Referring now to FIG. 10 there is illustrated how in these conditions scanning is implemented checked. In on-going scanning the angles of rotation φₜ₁ to φₜ₉ corresponding to the computed imaging instants t1 to t9 are continually sorted in size and subsequently the angular spacing d_{φ} between two adjacent angles of rotation φₜ in sequence computed. In scanning progress these angular spacings d_{φ} become increasingly smaller because of further individual measurements and thus intermediate positions are added all the time. Scanning is continued to advantage until the maximum existing angular spacing d_{φ} max drops below a predefined threshold value. To visualize scanning the scanned rotational positions of the wheel 1 are entered in a scale 11 of the degrees and displayed. Visualizing the process in this way can, of course, also be applied to all other aspect variants of the invention.

### LIST OF REFERENCE NUMERALS

1 wheel
2 tyre
3 drive shaft
4 light slice system
5 line laser module
6 camera
7 computer system
8 signal line
9 pulser
10 sensor
11 degree scale
12 axis of rotation
F image period
I wheel pulse
T period length
t time spacing, imaging instant
dt time interval
n number of wheel revolutions
t^{s} release time
φ axis of rotation
d_{φ} angular spacing

1. A method of three-dimensionally scanning fast-moving objects wherein the surface contour of an object is mapped by scanning the object with a light slice or fringe projection technique three-dimensionally characterized by
repeatedly moving the object past a scanner,
scanning portions of the object surface spatially offset relative to the portions scanned in the other passings of the object, and
generating said offset by the object surface being scanned by the scanner at different momentary positions of the object.

2. The method as set forth in claim 1, characterized by mapping each momentary position of the object in scanning the portions of the object surface relative to the scanner, transforming the contour-data of the scanned portions by means of the mapped momentary positions into a common object coordinate system and generating from the transformed contour data a surface model of the object.

3. The method as set forth in claim 2, characterized by determining the momentary positions of the object relative to the scanner each time by sensing the distance covered by the object relative to the scanner or the angle of rotation φ covered by the object relative to the scanner.

4. The method as set forth in claim 1 characterized in that the object performs relative to the scanner a periodic rotational motion or a periodic oscillatory motion.

5. The method as set forth in claim 4, characterized by generating a reference signal emitting at least once per period a synchronizing pulse (l₁ to l₁₆), the emitted synchronizing pulses l₁ to l₁₆ preferably synchronizing the imaging of a camera of the scanner to the motion of the object.

6. The method as set forth in claim 5, characterized in that the instant period length T of the rotational or oscillatory motion is obtained by the reference signal.

7. The method as set forth in claim 5, characterized in that sensing or computing imaging instants t₁ to t₉ is referenced to the synchronizing pulses l₁ to l₁₆ last received before or firstly after the corresponding imaging.

8. The method as set forth in claim 1, characterized in that for a camera of the scanner a constant imaging frequency is selected relative to the motional frequency of the object in a non-integer ratio.

9. The method as set forth in claim 8, characterized in that in scanning the portions of the object surface by the camera of the scanner the time spacing t₁ to t₉ between the instant of scanning and the instant at which the object has attained the reference position is sensed and mapped, the contour data of the scanned portions being transformed by way of the mapped time spacing t₁ to t₉ into a common object coordinate system.

10. The method as set forth in claim 9, characterized in that the time spacings t₁ to t₉ are measured by means of a real-time compatible microprocesor.

11. The method as set forth in claim 9, characterized in that to measure the time spacing t₁ to t₉ use is made of the image timing and image frequency or respectively the image period of the camera.

12. The method as set forth in claim 8, characterized in that in performing scanning, the spacing values between spatially adjacent portions are computed and the scanning discontinued as soon as the maximum value of all instant spacing values drops below a predefined threshold value.

13. The method as set forth in claim 1, characterized in that to scan the portions of the object surface at the various momentary positions of the object the camera of the scanner is exposed controlled In time to a precomputed imaging instant t₁ to t₉.

14. The method as set forth in claim 13, characterized in that in precomputing the imaging instants t₁ to t₉ each time spacing between two imaging instants (t₁ to t₉) in sequence Is selected larger than the image period T of a camera frame or camera field.

15. The method as set forth In claim 13, characterized in that a real-time compatible microprocessor is used for time-controlled imaging of the camera at predefined imaging instants t₁ to t₉.

16. The method as set forth in claim 13, characterized in that that the imaging of the camera is controlled by an external triggering of the camera or an external release of a mechanical or electronic camera shutter.

17. The method as set forth in claim 13, characterized in that the imaging of the camera is defined by the ON instant/duration of an illuminator of the scanner.

18. The method as set forth in claim 1, characterized in that to visualize the process a graphics display is used showing the position of the individual portions scanned on a stylized representation of the object or on a scale representing the momentary position of the graphics display preferably being continually updated during scanning.
